(19) United States
(12) Patent Application Publication
(10) Pub. No.: US 2021/0350459 A1
(43) Pub. Date: Nov. 11, 2021

(54) Diamond Asset Systems and Methods Facilitating Transactions, Valuation, and Securitization

(71) Applicant: FINE ART BOURSE AUSTRALIA PTY LTD, Sydney (AU)

(72) Inventors: Timothy David Goodman, Sydney (AU); Nicholas Fisher, Sydney (AU); Alan James Lee, Auckland (NZ)

(21) Appl. No.: 17/314,835

(22) Filed: May 7, 2021

Related U.S. Application Data
(60) Provisional application No. 63/021,203, filed on May 7, 2020.
(60) Provisional application No. 63/054,833, filed on Jul. 22, 2020.
(60) Provisional application No. 63/058,029, filed on Jul. 29, 2020.

(51) Int. Cl. G06Q 40/04; G06K 9/62; G06Q 40/08; G06Q 40/06

(52) U.S. Cl. CPC G06Q 40/04; G06K 9/6256; G06Q 40/06; G06K 9/6269; G06Q 40/08

(57) ABSTRACT

System and methods for managing and facilitating diamond asset transactions is disclosed. The system includes a processor configured to collect unique identifying information of a diamond asset in addition to continuously acquire applicable data derived from platforms including real-time sales data and wholesale prices of diamond assets. The aforementioned data is inserted in a machine learning module configured to apply one or more machine learning algorithms in order to generate real-time outputs associated with the diamond asset. The outputs and other applicable data of the diamond asset transaction are included in smart contracts configured to operated on a blockchain in which title of the diamond asset is securely executed and monitored on the blockchain.

### CROSS-REFERENCE TO RELATED APPLICATION

This application claims priority to U.S. Provisional Patent Application No. 63/021,203 filed May 7, 2020, U.S. Provisional Patent Application No. 63/054,833 filed Jul. 22, 2020, and U.S. Provisional Patent Application No. 63/058,029 filed Jul. 29, 2020, the entirety of which is incorporated by reference.

### FIELD OF THE INVENTION

The present invention relates generally to asset management, evaluation, and security. More particularly, management, evaluation, and security of diamond assets on a computer system that interfaces with a blockchain to store data and interact with blocks on the blockchain.

### BACKGROUND OF THE INVENTION

Throughout the last few years, the global diamond jewelry market has accumulated a worth of billions of dollars. Naturally, the exorbitant amount of value associated with this market generated a black market in which unverified and/or unauthentic diamonds put dealers, buyers, and other applicable parties for diamond transactions (lenders, insurers, evaluators, etc.) at risk of fraud. As a result, changes in the market have impacted traditional bank lending to the diamond industry causing significant pressure on the cashflow of diamond merchants.

Historically, the exchange of diamonds and diamond assets was rooted primarily on the diamonds being valued based on objective physical properties determined by an evaluating entity. Bringing the exchange of diamonds to a virtual platform has complicated this process due to the lack of up-to-date information relating to the status of a diamond (whether it is available for sale), the unavailability of a real-time market value of the diamond, and other applicable issues associated with supply and demand. The current platforms that exist for the wholesale online trading of diamonds enable sellers and buyers to transact offline or serve as escrow services in which the platform operators take a principal position of ownership of the diamond and ultimately transfer title to the buyer. For example, U.S. Pat. App. Pub. No. 2009/0070236 to Cohen et al., which describes a transparent diamond and precious stone trading platform and U.S. Pat. App. Pub. No. 2009/0125435 to Cohen et al., which describes a transaction method and system facilitating sales of diamonds or stones. However, these platforms not only fail to account for an accurate index of diamond values, but also they fail to account for secure and accurate financial instruments associated with the diamond configured to be traded for immediate exchange of cash as consideration. Furthermore, in the few instances in which an index is provided it does not account for immediate settlement, immediate delivery, immediate transparency, or publication of a sale of a diamond.

In addition, due to the lack of a centralized diamond verification agency, a unified diamond pricing standard, and overall transparency, multiple aspects of diamond and jewelry exchanges fall victim to inconsistency and sometimes fraud. Previous systems have attempted to combat this. For example, U.S. Pat. No. 8,239,211 to Feldman et al., describes a process to create a fungible global standard for diamonds and gemstones along with using future contracts based on resulting standardized baskets of gems as deliverables; however, the aforementioned process fails to account for an accurate and secure manner to validate essential components of the particulars of the contracts, such as current value of the diamond/gemstone based on contemporaneous factors. In addition, the aforementioned process requires a fixed predefined cut standard used as a base to determine the value of the diamond/gemstone, not allowing room for important variables necessary for proper evaluation. Lastly, the aforementioned systems fail to provide mechanisms that account for double lending, buyers defaulting on a diamond asset, defaulted diamonds being sold on the “white-market”, insurance fraud, and the trading of stolen diamonds.

What is needed is a centralized platform configured to manage diamond transactions in real-time allowing the diamond to be properly evaluated, verified, and have title transmitted to the buyer while circumventing the aforementioned issues.

### SUMMARY OF THE INVENTION

The invention provides a system and methods for managing and facilitating diamond asset transactions that overcomes the hereinafore-mentioned disadvantages of the heretofore-known devices and methods of this general type by utilizing a server to collect unique identifying information of a diamond asset in addition to continuously acquire sales data associated with an asset auction in order to generate an accurate up-to-date realizable value and applicable diamond asset insurance value for a particular diamond asset. The systems and methods provided herein take the next step of generating a financial instrument (hereinafter referred to as a smart loan and/or smart loan contract) memorializing the obligations of a designated buyer, seller, lender, and diamond asset evaluator. The invention also provides a system whereby wholesale asking price data is acquired from third party wholesale asking price platforms and used to calculate the average wholesale asking price for any diamond by third party wholesale diamond merchants who have laited their diamonds for sale on the platforms somewhat similar to classified advertising.

With the foregoing and other objects in view, there is provided, in accordance with the invention, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect of the claimed invention includes a system for facilitating transactions, valuation, and securitization of diamond assets including a processor designed and configured to: receive a plurality of unique identifying data associated with the diamond asset; register an asset identifier for the diamond asset on a distributed ledger; establish an obligation as a smart loan contract configured to be maintained on the distributed ledger based on the diamond asset identifier, wherein the obligation includes a designated evaluator; generate, based on a lender action provided by the lender, a first additional block memorializing the obligation; store as a second additional block, based on an evaluator action provided by the evaluator, an evaluation certification associated with the diamond asset; and establish a plurality of access rights to the first additional block based on the evaluation certification.

As a use-based example, the method and system may be configured to generate a spot market value of a diamond asset (a single stone or a packet or parcel of loose stones having generally similar characteristics) based upon (a) long-term historic diamond asset data sources (e.g., data from a database) which includes offers to sell and bids to buy (“offer/bid data”), and (b) actual diamond asset sales data. In one iteration, a six-year collection of historic offer/bid data is statically processed alongside the sales data in order to predict the then current spot market value of the diamond asset. Real time sales data may be obtained from auction sales data sources, wholesale value data sources, or other sources. An example of offer/bid data is data from the IDEX database. Since trends appear and then change (for example, the popularity of colored diamonds in the 2010 decade compared to the longer demand for colorless or near colorless diamonds in the 1990, 2000 decades), in which the more relevant trendlines appear in recent sales data. However, although consumers may be intrigued by colored stones, buying habits fall closer to historic colorless or near colorless stones. The operation of the predictive model is more complex when other diamond characteristics are accounted for such as new cuts and shapes of stones and the desire or lack thereof for fluorescence. Statistical analysis of sales versus historic offer/bid data noting stability, velocity and momentum operating on the eight (8) key diamond asset characteristics (these characteristics explained below) is accounted for by artificial intelligence (AI) or machine learning systems which (i) use historic offer/bid data against sales operable on the 8-way characteristics; (ii) on the fly, changeable statistical algorithms dependent on more than the carat weight of the asset; and (iii) time-based weighting again operable on the 8-way characteristics more than the carat weight of the asset. The time-based weight accounts for inflation (or deflation). This inflation factor may be based upon non-asset data such as the price of a commodity (gold, silver, oil, etc.) or other financial assets (M1, M2, M3, the DOW, S&P 500, Libor, etc.). Hence the input to the AI/machine learning processor is changeable in this spot market value process.

Another use-based model is designed to calculate the wholesale price of a stone which wholesale price only uses the offer/bid data and the time-based inflation/deflation sub-model. The same predictive statistical algorithms are used as discussed above in connection with the spot market price calculator model except sales data is not used. Rather than sales data being used, the spot market price calculator model is configured to utilize a plurality of variable data. In future iterations of the wholesale price model, historic (rather than real time) sales data may be used. To assist the suppliers and sellers of diamond assets, another use-based model generates a current price for an idealized diamond asset, sometimes called a “diamond standard.” The diamond standard is generally considered to be a fictional perfect 1.00 carat, round cut, D color; IF (Internally Flawless); Ex (excellent) cut; Ex (excellent) symmetry; Ex polish; and no fluorescence single stone. In another use-based model, the system and method creates and generates an insurable value for the diamond asset. The insurable value output uses as its baseline the wholesales price model and factors in and supplements that wholesale price with data representing the diamond asset mount (sometimes called a setting) which is oftentimes made of precious metal (gold, silver, platinum), a region-based retail markup and a region-based tax (if applicable). The insurable value can be used for several purposes, such as purchasing adequate insurance against loss or theft, mortgage lending and other transactions in the supply chain and as needed by the end-user or consumer.

In accordance with another feature, an embodiment of the present invention includes a method for facilitating transactions, valuation, and securitization of diamond assets including identifying a plurality of initialization feature values of the diamond asset; storing training data that comprises a plurality of training instances, each of which is derived from the plurality of initialization features values; using one or more statistical or machine learning techniques to train a classification model based on the training data; identifying a second plurality of feature values derived from a plurality of newly acquired data; correlating the second plurality of feature values to the plurality of initialization feature values; wherein correlating comprises inserting the second plurality of feature values into the classification model that generates an output that indicates the value of the diamond asset; and storing the output on at least one block on a distributed ledger.

In accordance with another feature, an embodiment of the present invention includes a system for generating an insurance valuation of a diamond asset including at least a processor designed and configured to: receive a plurality of unique identifying data associated with the diamond asset; receive a plurality of sales data (auction or other sales data) associated with an asset auction; receive an evaluation certification associated with the diamond asset; store training data that comprises a plurality of training instances, wherein each training instance in the plurality of training instances corresponds to at least one of the plurality of unique identifying data, the plurality of sales data, and the evaluation certification; use one or more statistical or machine learning techniques to train a classification model based on the training data and define a classification boundary based on the plurality of training instances; generate an output, based on the classification model and applying the classification boundary, representing an insured value for the asset; establish an obligation associated with the diamond asset configured to be maintained on the distributed ledger; generate a first additional block on the distributed ledger memorializing the obligation via a smart contract; and store the output and the evaluation certification on a second additional block on the distributed ledger.

Although the invention is illustrated and described herein as embodied in a system and methods for facilitating transactions, valuation, and securitization, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted; for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The term “machine learning” is taken to include procedures develop in the fields of Statistics and Computer Science. The terms “program,” “software application,” and the like as used herein, are defined as a sequence of instructions designed for execution on a computer system. A “program,” “computer program,” or “software application” may include a subroutine, an algorithm, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram depicting an exemplary system for facilitating transactions for diamond assets, according to an example embodiment;

FIG. 2 is a block diagram depicting an exemplary machine learning module utilized by the system for facilitating transactions for diamond assets of FIG. 1, according to an example embodiment;

FIG. 3 is a block diagram depicting an exemplary implementation of management of a distributed ledger utilized by the system for facilitating transactions for diamond assets of FIG. 1, according to an example embodiment;

FIG. 4 is a block diagram illustrating an exemplary method for facilitating transactions, valuation, and securitization of diamond assets, according to an example embodiment;

FIG. 5 is a block diagram illustrating a flowchart wherein data flows from a platform to a machine learning module to various modules of the system for facilitating transactions for diamond assets, according to an example embodiment; and

FIG. 6 illustrates a computer system according to exemplary embodiments of the present technology.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and unconventional system for facilitating transactions for diamond assets, a method for generating a value of a diamond asset, and a system for generating values generally associated with transactions involving diamond assets, including but not limited to wholesale asking prices, insurance quotes, trading prices, and any other applicable values. In some embodiments, a smart loan contract is generated and managed on a distributed ledger configured to include a plurality of blocks in which each block of the plurality of blocks stores a component associated with the diamond asset and/or the smart loan. In some embodiments, the present invention further includes a machine learning device and machine learning methods configured to perform one or more machine learning techniques on training instances derived from the received plurality of unique identifying information of the diamond asset and sales data from applicable platforms in order to not only create a diamond standard and diamond spot market index reflecting current price and evaluation fluctuations, but also to generate a current value of the diamond asset configured to be included in the smart loan contract. Thus, the system and methods described herein provide improvements to the identification, evaluation, and management of transactions involving diamond assets ultimately improving authenticity and security associated with the aforementioned; therefore, circumventing fraud inherent to diamond asset transactions. The system is able to provide users with a current value of a diamond asset based on factors such as physical characteristics of the diamond asset in addition to current sales data that establishes the diamond spot market index. In addition, the system and methods described herein provide improved functioning of computing systems by optimizing big data processing and utilizing deep learning networks/deep neural networks in a scalable manner that reduces the required overhead of computing resources for embedded and mobile networks. Additionally, the system and methods described herein provide improved blockchain generation and functionality that circumvents inherent latency issues. As described herein, the term “diamond asset” includes both single diamond stones as well as packets or parcels of stones having a defined range of diamond characteristics (size, weight, cut, color, clarity, fluorescence, symmetry, shape, polish, girdle, cutlet presence, etc.).

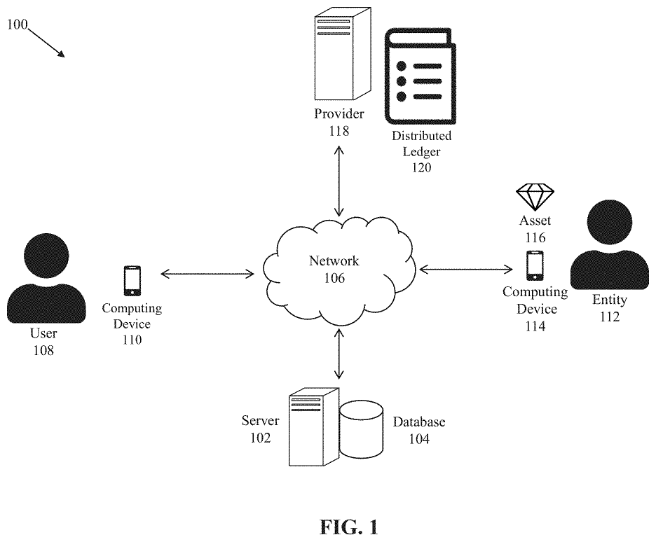

Referring now to FIG. 1, a system for managing diamond assets 100 is depicted according to an exemplary embodiment. In some embodiments, system 100 includes a server 102, a database 104, a communications network 106, a user 108 (hereinafter referred to as “buyer”), a computing device 110 associated with buyer 108, at least one entity 112, a computing device 114 (or collection of computing devices) associated with entity 112, and a diamond asset 116 which is the nexus between buyer 108 and entity 112. In some embodiments, system 100 further includes a provider 118 configured to generate and manage a distributed ledger 120, in which server 102, computing devices 110 and 114, and provider 118 are communicatively coupled over network 106. System 100 is a computer-based system and the various components of system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. System 100 illustrates one of many possible arrangements of components configured to perform the functionality described herein; however, other arrangements may include fewer or different components, and the division of work between the components may vary depending on the arrangement. As described herein, computing devices 110 and 114 and any other applicable computing device of system 100 includes but is not limited to a mobile phone, tablet, smart phone, desktop, laptop, wearable technology, or any other applicable device or system including at least a processor. In some embodiments, the servers mentioned in this disclosure may be a stand-alone and/or enterprise-class servers operating a server OS such as a MICROSOFT® OS, a UNIX® OS, a LINUX® OS, or other suitable server-based OS. One or more servers may be operated and/or maintained by the same or different entities. Server 102 and machine learning server 114 may be implemented in hardware, software, or a combination of hardware and software. Network 106 may be implemented as a Local Area Network (LAN), Wide Area Network (WAN), mobile communication network (GSM, GPRS, CDMA, MOBITEX, EDGE), Ethernet or the Internet, one or more terrestrial, satellite or wireless links, or any medium or mechanism that provides for the exchange of data between the aforementioned components of system 100.

In some embodiments, server 102 is configured to generate a platform configured to function as a centralized platform for managing diamond asset transactions in which the platform includes a plurality of user interfaces configured to receive inputs from buyer 108 and entity 112 via computing devices 110 and 114 respectively. Database 104 is designed and configured to house a plurality of records associated with at least one of buyer 108, entity 112, and/or diamond asset 116, in which server 102 is configured to scour/crawl websites associated with trading platform, brokers, and auction houses of fine art, jewelry, and other collectibles, continuously collecting data associated with diamond assets as they become available for sale and storing the collected data in the applicable record. In some embodiments, server 102 is configured to continuously receive a plurality of sales data associated with diamond assets from third party platforms such as, but not limited to trading platforms, Sotheby, auction house web platforms, diamond brokers, or any other applicable party. Server 102 may assign an asset identifier unique to diamond asset 116 not only allowing the record housed on database 104 associated with diamond asset 116 to be identified and retrieved for presentation on the centralized platform, but also providing a registration mechanism that allows the asset identifier to be integrated on distributed ledger 120 to identify diamond asset 116 and transactions involving diamond asset 116. In addition to registering a diamond asset, the centralized platform provided by server 102 is further configured to provide a diamond standard index (DSX) derivative functionality configured to be integrated into financial instruments allowing securitization of a plurality of tokens and/or funds (fiat currency) associated with diamond asset 116 by users for various windows of time. This allows real-time value to be applied to not only a theoretical perfect diamond asset 116 configured to be symbolized by the plurality of tokens, but also allows financial instruments to automatically account for initial, maintenance, minimum, maximum, and any other applicable margin requirements associated with the transactions of diamond asset 116. It is to be understood that one of the foundational purposes of system 100 is to validate and verify the authenticity of diamond asset 116 and any applicable data associated with diamond asset 116 received from one of the aforementioned platforms prior to diamond asset 116 being listed as available for sale on the centralized platform operated by server 102. In addition, the centralized platform is designed and configured to support sales for users desiring to go long or short utilizing DSX derivative functionality provided by server 102. As described herein, a diamond asset may be a diamond, melee diamonds, gem stones, or any other applicable collectible configured to be sold and/or auctioned. In some embodiments, prior to diamond asset 116 being listed on the centralized platform, diamond asset 116 is evaluated by entity 112 under the circumstances in which entity 112 is and/or includes a certified diamond evaluator/appraiser such as but not limited to Gemological Institute of America (GIA), American Gem Society (AGS), International Gemological Institute (IGI), European Gemological Laboratory (EGL), Gemological Science International (GSI), Hoge Raad Voor Diamant (HRD), De Beers Group Industry Services, or any other applicable gemstone certification entity.

It is to be understood that entity 112 may be a single entity or a plurality of entities in which the plurality of entities includes one or more of a designated seller, underwriter, lender, borrower, auctioneer, evaluator/appraiser, insurer, and/or any other applicable party known to those of ordinary skill in the art configured to be included in a diamond asset transaction. In some embodiments, a plurality of unique identifying data associated with diamond asset 116 is received by server 102 via one or more apparatuses and/or mechanisms configured to acquire the physical characteristics of diamond asset 116, in which the one or more apparatuses and/or mechanisms is communicatively coupled to server 102. For example, diamond testing devices, screening equipment, photonic devices, and any other applicable mechanism may be utilized to acquire physical characteristics of diamond asset 116, with or without a human evaluator, such as, but not limited to size, weight, cut, color, clarity, fluorescence, symmetry, shape, polish, girdle, cutlet presence, or any other applicable ascertainable physical characteristics. This diamond asset identifying data is received by server 102, integrated into a record housed on database 104, and associated with diamond asset 116 via a diamond asset identifier via server 102. An applicable evaluator of and/or associated with entity 112 may input this identifier data into server 102, or the server 102 may acquire this identifying data from another diamond transactional platform via an upload/download operation, for a particular diamond asset. In the case of a data processing operation, the data set from the source platform is updated by intermediary modules to match the format and fields in the server 102. In some embodiments in which entity 112 includes a designated evaluator, the plurality of unique identifying data is validated by the evaluator in order for diamond asset 116 to be listed for sale on the centralized platform in which the evaluator generates a unique embedded code representing a validation of the plurality of unique identifying data (physical characteristics) of diamond asset 116. As is known in the industry, given that the diamond has many standard characteristics, the evaluators' data is used, in general, to identify a particular stone. The evaluator's certificate, for example, a GIA certificate, contains data to particularly identify the diamond. There are prior art platforms supporting offers to sell and bids to buy diamonds and oftentimes the evaluator's certificate is readily available. These prior art platforms sometimes have all or nearly all the diamond characteristic identifier data for these stones up for sale. Hence the evaluator data can be downloaded from these prior art buy/sell platforms into server 102. As for a parcel or packet viewed as a single diamond asset in the trade, these parcels are a collection of stones having a defined range of diamond characteristics (size, weight, cut, color, clarity, fluorescence, symmetry, shape, polish, girdle, cutlet presence, etc.). For example, a 1 carat stone represents 100 points. Each stone is a parcel of melee stones and/or is an extraordinarily small diamond having a size range between 21-74 points. A parcel of star diamonds is a collection of stones each having a carat range of about 9-21 points, and some consider these stars to resemble a “diamond dust” appearance. In either case, the parcel of melee stones may have 24 stones in a weight range of 20-50 points, having reasonable color, clarity, fluorescence. Parcels and packets are sold and traded based upon total carat weight. Using common diamond characteristics, these parcels or packets are typically traded as a single diamond asset 116, which can be processed by the present invention. The present invention supports a financial system, handling single stones as diamond asset 116 and, in other cases, packets of stone having a relatively defined carat weight range and having a relatively defined range of similar characteristics of cut, color, clarity, fluorescence, symmetry, shape, and polish.

It is to be understood that provider 118 is a blockchain provider and applicable computing device configured to generate a blockchain and manage blockchain functionality, in which a blockchain is described herein as a distributed database, embodied as distributed ledger 120, configured to maintain a continuously-growing list of records secured from unauthorized modification. In some embodiments, distributed ledger 120 includes a plurality of blocks associated with diamond asset 116 in which each block of the plurality of blocks serves as an interaction record and each block includes a timestamp and a link to a previous block. In some embodiments, a plurality of additional blocks may be appended to distributed ledger 120 configured to include data provided by computing device 114 once server 102, provider 118 and/or the applicable verifying party validates the respective block. In some embodiments, a copy of distributed ledger 120 is maintained by a verification network operated by provider 118 allowing each node including at least one of server 102, computing device114, and provider 118 to use distributed ledger 120 to verify transactions. In some embodiments, distributed ledger 120 may integrate cryptographic security mechanisms along with token management functionality wherein provider 118 manages and maintains mapping of tokens based on the source of which the token is relating to.

In some embodiments, server 102 is configured to generate one or more smart contracts associated with at least buyer 108, entity 112, and diamond asset 116 in which some configurations support interconnectivity between server 102 and provider 118 allowing the smart contracts to be integrated in distributed ledger 120. In some embodiments, the one or more smart contracts are configured to be continuously scanned/traversed by server 102 allowing components of the one or more smart contracts to be updated if necessary by the applicable party upon the detection of inaccuracies or inconsistencies of the data included therein. It is to be understood that the one or more smart contracts may be financial instruments memorializing the obligations of one or more of the designated buyer, seller, underwriter, lender, borrower, auctioneer, evaluator/appraiser, insurer, and/or any other applicable party associated with the transaction of diamond asset 116. For example, each of the one or more smart contracts may be securitized by diamond asset 116, in which a first smart contract relates to a designated lender and a designated borrower of diamond asset 116, a second smart contract may embody a default insurance policy associated with diamond asset 116 including a designated insurer/underwriter, and a third smart contract may embody an evaluation certification associated with diamond asset 116 including a designated evaluator/appraiser. As known in the prior art, the smart contract can be programmed to accept, for example, notice of release of funds by a lender, and notice of discharge of debt by the lender once the buyer pays off the debt, in which the action of the lender is applied by computing device 114. The smart contracts may have other program features as needed by the parties to any particular transaction. In some embodiment, server 102 includes one or more security mechanisms configured to protect identities and/or locations of parties of the transaction of diamond asset 116. For example, server 102 may be configured to utilize the centralized platform to obtain the geographic location of computing devices 110 and 114 circumventing theft or misplacement of diamond asset 116 by buyer 108 and/or a borrower. In some embodiments, the centralized platform includes a centralized diamond mortgage register configured to monitor for misplaced, stolen, and defaulted on diamond assets based on diamond asset identifiers.

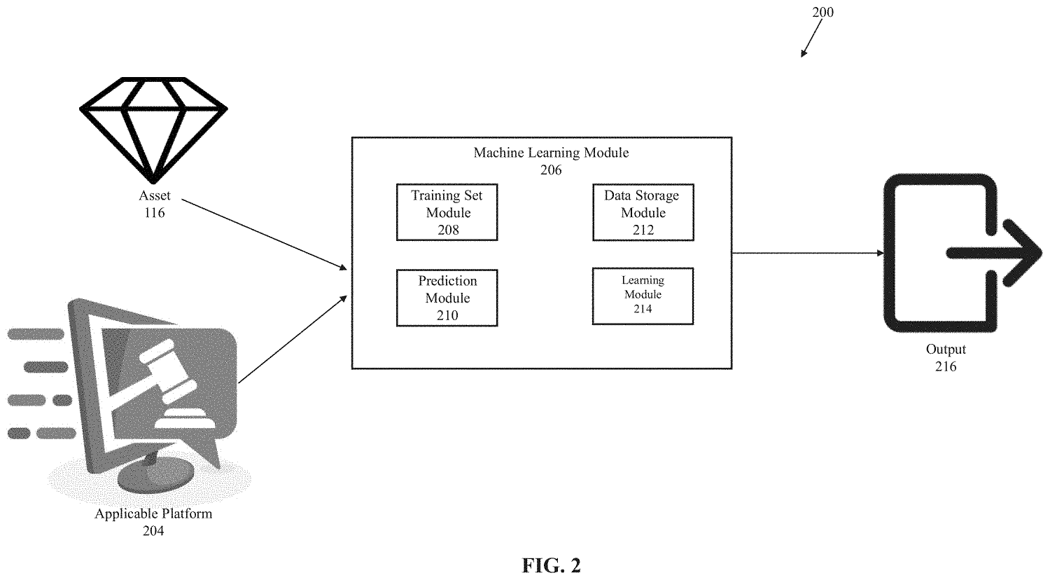

Referring now to FIG. 2, a data flow 200 illustrating generation of an output associated with diamond asset 116 is depicted, according to an exemplary embodiment. In some embodiments, the plurality of unique identifying data derived from diamond asset 116 along with a plurality of sales data derived from an applicable platform 204 is received by a machine learning module 206. Applicable platform 204 may include sources of actual diamond asset sales, IDEX, auction platforms, Zee Xchange, or any other applicable platform or source for sales data. In some embodiments, sales data may include a plurality of auction data, actual diamond asset sales data, wholesale asking price data, or any other applicable source of data configured to be used to account for a current value and factors impacting the current value of diamond asset 116. In some embodiments, machine learning module 206 does not receive the plurality of sales data, and instead receives a plurality of variable data configured to include one or more of a wholesale price for diamond asset 116, a price associated with a mount/setting or housing for diamond asset 116 composed of one or more elements, a regional-based retail markup, and a regional-based tax. Machine learning module 206 may receive the plurality of variable data in order to generate the output of one or more insurable values for diamond asset 116 configured to be integrated into distributed ledger 120.

It is to be understood that machine learning as described herein is the study and construction of algorithms that can learn from, and make predictions on, data. Such algorithms operate by building a model from inputs in order to make data-driven predictions or decisions via a prediction module 210 with assistance from a learning module 212 configured to include one or more artificial intelligence algorithms and machine learning algorithms. Thus, a machine learning technique utilized by machine learning module 206 is configured to generate a statistical prediction derived from data that is trained based off of data from a training set module 208 and is subsequently stored in data storage module 212. The machine-learned model is trained based on multiple attributes described herein. In machine learning parlance, such attributes are referred to as “features”.

In some embodiments, the plurality of unique identifying data may include but is not limited to cut, carat, color, clarity, weight, and any other applicable characteristics of diamond asset 116. In some embodiments, the plurality of sales data includes but is not limited to total number of trading platform data, bids and bidders of an auction, purchase history of diamond assets subject to the auction, lowest bidder, highest bidder, priority bidder, auction estimated value of diamond asset, date of an applicable sale, location of a particular auction, name/reputation of auction house, and any other applicable type of data inherent to a configured to be associated with diamond assets. In some embodiments, machine learning module 206 is configured to receive an evaluation certification issued from entity 112 on one or more diamond assets in which the certification may include an evaluator's information, an oath that the evaluation certification has been issued by an applicably licensed gemstone evaluator, date of evaluation, and any other applicable information associated with rendering an estimate/appraisal of a collectible item. It is to be understood that machine learning module 206 and its components utilize the aforementioned received data to train a classification model. In some embodiments, the plurality of training instances each include a plurality of feature values extracted from the aforementioned data received by machine learning module 206. Feature values are a subset of diamond characteristics, namely weight, cut, color, clarity, fluorescence, symmetry, shape, polish, girdle, and cutlet presence, etc. The extracted feature values are considered by a rule-based or a machine-learned model, in which if the model is a machine-learned model, then one or more machine learning techniques are applied. For example, the feature value rule may be all 1 carat stones, round, clarity VS-VVS, color D, perfect cut, etc. In some embodiments, the machine learning techniques are used to learn relative weights of features of diamond asset 116, which weights are then used to assist in generation of one or more outputs 216 of machine learning module 206. In one embodiment, the classification model is generated based on training data using one or more machine learning techniques as opposed to a rule-based classification model. In any event, the model being used should capture nonlinear correlations. Given that the characteristics are weight, cut, color, clarity, fluorescence, symmetry, shape, polish, girdle, and cutlet presence, this 8-way (or other diamond characteristic combination) classification system in an enhanced system cannot be solely rule-based. One type of training data may be based upon near-term historical offers to sell and bids to buy data (e.g., offers/bids over a prior two year period) supplied by prior art trading platforms. Although the training data set may not have a listing for every stone, once the 2-year training set configures the classification model, a larger training set, say past sales in year three and year four (corrected for inflation), can be run through the classification model to see if the model predicts completed sales in the near term, 2-year period. Also, the 2-year partly trained classification model may operate on a one-year collection of recent sales or auction data (the closing auction bid being withheld as a test TRUE answer set). If the classification model reasonably predicts the near term auction sales, then the model operates well. If NO, then more comprehensive training data is needed. The machine learned classification model utilizes probabilistic machine learning methods applied by learning module 214 that result in intuitive classifications utilized to generate an output 216 reflecting an estimated value of diamond asset 116 for not only visual representation on respective user interfaces of computing devices of computing devices 110 and 114, but also for integration into distributed ledger 120. For example, output 216 is generated and server 102, alone or in combination with provider 118, integrates output 216 into the smart contract and stores the smart contract on distributed ledger 120. In some embodiments, machine learning module 206 utilizes the acquired data to establish a current and/or real-time diamond index representing not only a diamond pricing metric for diamond asset 116, but also a standard for diamond asset 116 hereinafter referred to as a plurality of initialization feature values. It is to be understood that the plurality of initialization feature values may be generated and/or identified during the data extraction process of physical characteristics of diamond asset 116 and/or plurality of sales data allowing the plurality of initialization feature values to serve as parameters of the mathematical model. In some embodiments, learning module 214 utilizes the plurality of initialization feature values to correlate the plurality of feature values in which the correlating of the plurality feature values includes inserting the plurality of feature values into prediction module 210 allowing machine learning module 206 to generate output 216 reflecting newly acquired data. The centralized platform is configured to provide users access to the diamond spot market index generated based on the data received by machine learning module 206. In particular, the diamond spot market index is measured by data acquired by machine learning module 206 in addition to data included in output 216 (outputs generated collectively by machine learning module 206), smart contracts generated by server 102, and/or diamond assets listed as available on the centralized platform.

In some embodiments, a neural network can be trained using the training data which may be configured to include input data and the correct output of the model for the corresponding input data. It is to be understood that machine learning module 206 is designed to not only generate output 216, but also assist server 102 in generating one or more smart contracts integrating data from the plurality of unique identifying data, the plurality of sales data, or any other applicable data utilized by machine learning module 206. For example, the generated smart contract may integrate the plurality of unique identifying data in the smart contract relating to diamond asset 116, output 216 reflecting the up to date value of diamond asset 116, and a certification provided by entity 112 validating the aforementioned each of which are stored on blocks of distributed ledger 120 in a subsequential manner.

In some embodiments, training set module 208 includes a plurality of training data configured to include a plurality of training instances in which each training instances corresponds to data received by machine learning module 206. For example, the plurality of unique identifying data, the plurality of sales data, and any other applicable data associated with diamond asset 116 may be represented in the training instances. In some embodiments, training instances are input into a parameter estimation module designed and configured to estimate applicable parameters of the statistical model of the underlying data (if not initialization feature values are present), and in some embodiments where no training instances are available they can be created from prior data of the previously used machine learning algorithms. In some embodiments, a new machine-learned model is generated regularly and the new machine-learned model may replace a previous machine-learned model allowing newly acquired or changed training data sourced from applicable platform 204 or other applicable source to be used to update the model. It is to be understood that the most recent data associated with diamond asset 116 is utilized when the smart contracts are generated. For example, fluctuation of the value of diamond asset 116 is common due to current demand and other applicable factors; thus, machine learning module 206 is designed and configured to generate an updated output 216 reflecting the up-to-date value of diamond asset 116 based on the most current factors including but not limited to current diamond rate per carat, current diamond standard, Rapaport price list, or any other applicable adjusting factor. In this manner, the insured or insurable value of the stone is ascertainable by the insuring parties by read-only access rights to distributed ledger 120 or blockchain. Server 102 integrates the updated output 216 into distributed ledger 120 in the applicable block.

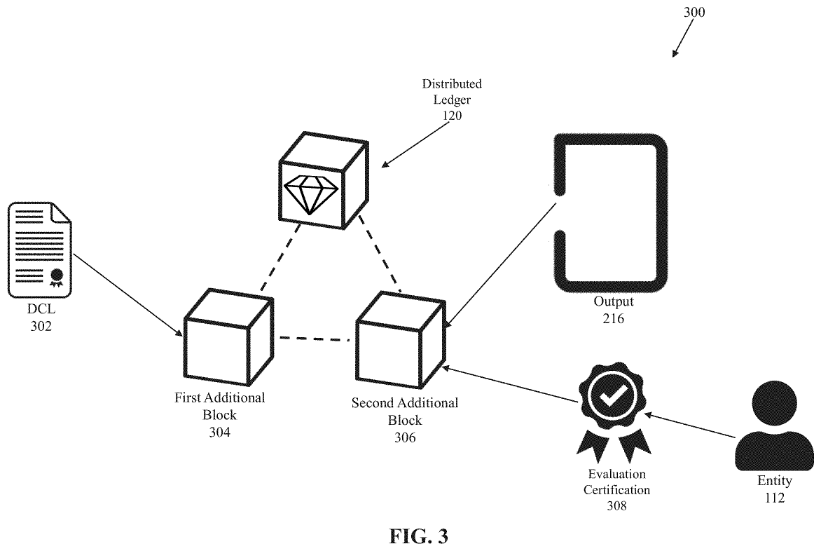

Referring now to FIG. 3, an implementation 300 illustrating management of distributed ledger 120 is depicted according to an exemplary embodiment. In some embodiments, server 102 is configured to generate a diamond collateralized loan (DCL) 302 associated with diamond asset 116 in which DCL 302 may be generated before, during, or after provider 118 generates distributed ledger 120. Although DCL 302 is intended to be a financial instrument memorializing the obligations associated with the transaction involving diamond asset 116, it is to be understood that DCL 302 may include and/or be associated with additional smart contracts configured to be integrated into distributed ledger 120 including but not limited to insurance policies, diamond certification documents, supplemental collateralized loan agreements, and any other applicable financial instrument relating to diamond assets known to those of ordinary skill in the art. In a preferred embodiment, DCL 302 is between buyer 108 serving as a borrower and entity 112 specifically defining diamond asset 116 as collateral in which entity 112 includes at least a designated lender. DCL 302 is configured to insure the lender against loss or damage caused by a default of buyer 108 in an event that the lender is unable to recover diamond asset 116. In addition to DCL 302 being integrated on distributed ledger 120 based on the diamond asset identifier associated with diamond asset 116, DCL 302 is further configured to be stored on a first plurality of additional blocks 304 included on distributed ledger 120 wherein read and/or write privileges are allocated to first plurality of additional blocks 304 (and any applicable subsequent blocks) via server 102 and/or provider 118 based on the source. Distributed ledger 120 includes a second plurality of additional blocks 306 configured to store output 216 in addition to any applicable tokens, validation markings, or any other applicable substantiation configured to be issued by server 102, entity 112, and/or provider 118. In some embodiments, server 102 and/or provider 118 adds or integrates substantiations to distributed ledger 120 based on one or more actions performed by entity 112 on computing device 114. For example in the instance where entity 112 is and/or includes the designated evaluator, the designated evaluator is configured to generate an evaluation certification 308 configured to validate that diamond asset 116 is in existence along with confirm that the plurality of unique identifying information associated with diamond asset 116 and output 216 reflecting the most up to date value of diamond asset 116 are all verified. Server 102 and/or provider 118 is configured to store evaluation certification 308 on at least one of plurality of additional blocks 304 and 306. Evaluation certification 308 is important for establishing valuations of diamond asset 116 regardless of diamond asset 116 being a component of a jewelry set including a diamond or multiple diamonds. In some embodiments, server 102 and/or provider 118 is configured to allocate one or more access rights to respective blocks of distributed ledger 120 based upon what is being added to distributed ledger 120 in addition to the source that is adding to distributed ledger 120 and the party requesting access to distributed ledger 120. For example, in the instance where entity 112 is and/or includes a designated underwriter, server 102 is configured to allocate access to one or more of plurality of additional blocks 304 and 306 based upon the designated underwriter indicating the existence of insurance on diamond asset 116. As further example, the evaluator has read and write access rights to distributed ledger 120, but the write rights are one-time rights as to the evaluation certificate data. Once entered in the distributed ledger 120, the evaluator's subsequent access is denied. Buyer 108 may have read-only access rights for a prescribed time. Sellers also have read-only access rights once diamond asset 116 is on distributed ledger 120. The underwriter has write-once access rights and may have long term read-only rights subject to the time period of insurance. Lenders have writing access rights when the funds are released and when the loan is paid-off or discharged. Stated more broadly, read-only access rights are permitted for as long as a party has a financial interest pending on distributed ledger 120, and thereafter his or her rights are withdrawn by operation of distributed ledger 120 or blockchain program.

It is to be understood that in order to maintain functionality of distributed ledger 120, server 102 and/or provider 118, alone or in combination, are configured to allocate output 216, DCL 302, and any other component configured to be allocated to a blockchain on any of the blocks of distributed ledger 120 subject to the applicable configuration. The configuration of the centralized platform provides the designated lender and/or any other applicable party of entity 112 (trustee, liquidator, administrator, etc.) the ability to obtain possession and/or title of diamond asset 116 securitized by DCL 302, in which entity 112 (in particular, the designated lender) maintains title of diamond asset 116 during the term of DCL 302 and furnishes title of diamond asset 116 to buyer 108 upon settlement of all terms of DCL 302.

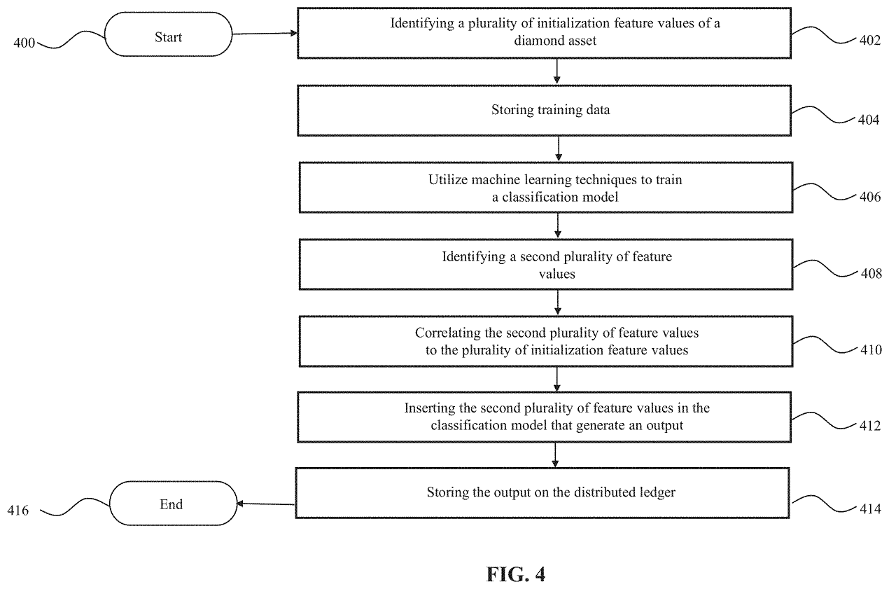

Referring now to FIG. 4, a method of generating a value of a diamond asset 400 is depicted according to an exemplary embodiment. It is to be understood that the centralized platform operated by server 102 is designed and configured to continuously update and present, on applicable user interfaces, the real-time value of diamond asset 116 in addition to the diamond spot market index based on the real-time value of diamond asset 116 and the evaluation fluctuations derived from data received by machine learning module 206. The term “continuously” in that insurance operation can mean for a defined period of time, for example, yearly. More unique or precious, insurance for rare stones may have a quarterly or monthly predicted price. At step 402, server 102 identifies a plurality of initialization feature values of diamond asset 116. The plurality of initialization feature values may be used to train and test learned functions configured to assist learning module 214 perform its designated function. Initialization data as described herein is a set of big data and/or subset of big data configured to have derivatives reflected via the plurality of training instances. In some embodiments, initialization data may include but is not limited to plurality of unique identifying information of diamond asset 116, the plurality of sales data received from applicable platform 204, diamond spot markets, listings of applicable diamond vendors, and/or a combination thereof. The initialization data is configured to be continuously transmitted to machine learning module 206 by server 102 over network 106. At step 404, the plurality of training instances, each of which reflect derivatives of the plurality of initialized feature values, operated and managed by training set module 208 is stored in data storage module 212. At step 406, machine learning module 206 utilizes one or more machine learning techniques to train the classification model via learning module 214. At step 408, server 102 identifies a second plurality of feature values to account for updated and/or newly added data associated with at least one of diamond asset 116, the diamond standard, diamond spot market index, evaluation certifications, and/or outputs generated by machine learning module 206. It is to be understood that one of the purposes of server 102 continuously identifying initialization feature values is to continuously transmit acquired data from one or more of the aforementioned sources to training set module 208 to establish one or more classification boundaries (classification thresholds) relating to what is useful data to generate the most accurate output 216. At step 410, learning module 214 correlates the second plurality of feature values to the plurality of initialization feature values in order to discover correlations between one or more features that relate to diamond asset 116. It is to be understood that prediction module 210 is configured to utilize probabilistic models receiving instances of one or more features as input, or the output results of other learned functions. This allows the correlation step to determine which characteristics and/or features of the data received by machine learning module 206 allow machine learning module 206 to generate the most accurate output 216 representing a real-time or most up to date value of diamond asset 116. At step 412, the second plurality of feature values is inserted into the classification model resulting in output 216 being generated. It is to be understood that if output 216 is associated with diamond asset 116 then output 216 will be stored in the record associated with diamond asset 116 housed in database 104 allowing server 102 to determine which applicable output 216 should be inserted into distributed ledger 120 based on the asset identifier. In some embodiments, applicable parties associated with system 100 are configured to search and/or receive notifications via a strict privacy protocol in which server 102 determines which applicable party is a permissioned party to access distributed ledger 120 and its content. For example, during an auction, access rights to the predicted price can provide real-time data to the buyer or seller. Prior to the auction, access rights to real-time data could be restricted to enhance the seller's position. It is to be understood that access may be limited based upon at least one of the party requesting access, the data included on the particular block of distributed ledger 120, and/or the parties of DCL 302. Access rights are discussed earlier herein. At step 414, server 102 and/or provider 118, alone or in combination, store output 216 on at least one of first and second plurality of additional blocks 304 and 306 in which the process ends at step 416. It is to be understood that distributed ledger 120 is designed and configured to be accessible to buyer 108 and/or entity 112 based upon request made by the applicable party to provider 118. For example, the designated lender may wish to determine if diamond asset 116 has been double-lended or defaulted on, or if evaluation certification 308 was added to distributed ledger 120 before or after the designated underwriter added the insurance policy associated with diamond asset 116 to distributed ledger 120. Third parties, external to system 100, such as banks, law enforcement, insurance industry, diamond merchants and any other applicable parties, may initiate requests to access distributed ledger 120 in which discretion to allow access and/or limited access is based upon a determination by server 102 and/or provider 118. It is to be understood that server 102 and/or provider 118 is configured to transmit title of diamond asset 116 via transmission of DCL 302 in which each transmission of DCL 302 is registered on distributed ledger 120 for tracking/security purposes. In the case in which DCL 302 is defaulted on by buyer 108, server 102 automatically transmits title of diamond asset 116 to entity 112 based on server 102 determining that the designated lender is unable to recover the diamond asset within a predetermined period of time.

As to the training sets, at least two, and maybe more, sets of training data are uploaded into system 100 by the server 102. Currently the IDEX offer/bid, multi-year historic data on the asking price for diamond sales and 5-yr historic auction sales data on the actual sales price for diamond transactions is used as a training set. With these training data sets, apply one or more statistical algorithms to generate the value of diamond asset 116. Real time inputs are continuously gathered from applicable platform 204, first diamond sales data from auctions and other sales data sets and IDEX diamond asking price data (offer/bid data), then other diamond data sources. APIs are developed for these diamond data source platforms. As for the algorithms, statistical formulas are applied to historic data to establish the historic relationship between spot market auction or sales data and wholesale offer/bid data. The system predicts the prices of the target diamond standard (value of the diamond asset) referred to above. Statistical formulas are applied to historic data to establish the historic relationship between spot market sales data and wholesale price data. Having applied that statistical relationship to the sales price data, the systems then predict firstly, the realizable price of the subject diamond stone (or parcel) at auction (the spot market value) and in another embodiment of the invention, secondly, the predicted wholesale price of the diamond asset. Statistical formulas are applied to current and historic data to establish the retail price of diamond asset 116 or a piece of diamond jewelry suitable for insurable purposes. Estimated time to deliver data to customer or subscriber is nearly instantaneous, the target response time being 2-3 seconds.

Predictive algorithms may integrate, in addition to the server-acquired diamond asset platform data, other data, such as inflation rate (e.g., CPI), commodities index data (gold, oil, silver, copper, etc.), equity indexes (e.g., S&P 500, DOW), bond index (e.g., Barclays Aggregate), cash flows (e.g., Ml, M2, M3), interest rates (e.g., Libor), the US stock market FEAR index (e.g., VIX). Each data input set will have its own API which is a data portal used by the server.

As for insurable value, given a time frame for the insurance coverage, predictive algorithms generate an insurable value of a certain diamond asset (including data on the diamond mount manufactured from precious metal, typically part of the evaluation data supplied by the evaluator). As known, insurance works on the concept of retail replacement value, and given various data input platforms, the system predict a diamond asset retail replacement value over a fixed period of time. The keys to this algorithm are, current diamond asset price, price of precious metal, the cost of manufacturing the mount, indirect tax, regional currency and the general retailer's mark-up accepted by self-regulatory jewelry industry organizations. All this results in a replacement/insurable value for the diamond asset.

As for the smart contracts, blockchain auction process above can be automated with a smart contract. An escrow agent would hold the diamond asset until the smart contract releases the diamond asset title to the buyer.

One current embodiment of the predictive algorithm uses a concept of a diamond standard to reflect the multi-year historic data on the asking price for diamond sales and the multi-year historic auction sales data on the actual sales price for diamond transactions. The prior art IDEX offer to sell and bid to buy data base typically does not include sales data. However, the sales data base includes auction sales data. These two distinct data sources are used to predict the value of a fictitious “diamond standard” value idealized as a perfect 1.00 carat, round cut, D color; IF (Internally Flawless); Ex (excellent) cut; Ex (excellent) symmetry; Ex polish; and no fluorescence. The diamond standard can be used as a visual guide to the diamond sellers when graphically presented alongside the spot market value via one or more user interfaces. By analogy, the graphic presentation of the fictitious diamond standard alongside the spot market value permits the diamond seller and buyer to accept or modify his or her opinion as to the accuracy of the predicted spot market value of the diamond asset. The predictive algorithm uses statistical tools accounting for, among other factors, the frequency of the target asset subject to the predictive model in the bid/offer and the auction sales databases, the variation between the subject target asset and the data in the databases, and the resulting variation in pricing. The plurality of initialization feature values is found in the diamond assets in the bid/offer and the auction sales data bases used as training data. The second plurality of newly acquired data is the information about the subject target asset. In one embodiment, the correlation of the second group of feature values to the initialization feature values is the statistical relationship in the bid/offer and the auction sales databases and the subject target asset. Of course, the statistical analysis may account for the age of the data in the bid/offer and the auction/sales data bases, inflation (e.g., the price of gold in the mount of the subject diamond), differentials between data in the historic data bases (e.g., the DIA-1 being 1.5 carat, round cut, E color; VVS; IF (Internally Flawless); Ex (excellent) cut; Ex (excellent) symmetry; Ex polish; and no fluorescence compared to the target DIA-2 as 1.45 carat, round cut, D color; VS; Ex (excellent) cut; Ex (excellent) symmetry; Ex polish; and medium fluorescence. If the historic databases have data on both DIA-1 and DIA-2, then the relationship from the historic diamond standard and DIA-1, 2 may be the same correlated relationship to the present day diamond standard and DIA-1 (the current target). Given the multi-variable diamond characteristics (size, weight, cut, color, clarity, fluorescence, symmetry, shape, polish, girdle, cutlet presence, etc.), the quality or absence of “identical data” to the target data, and the highly changeable nature of the market (historic vs present day), statistical correlations are the best fit to predict diamond asset value.

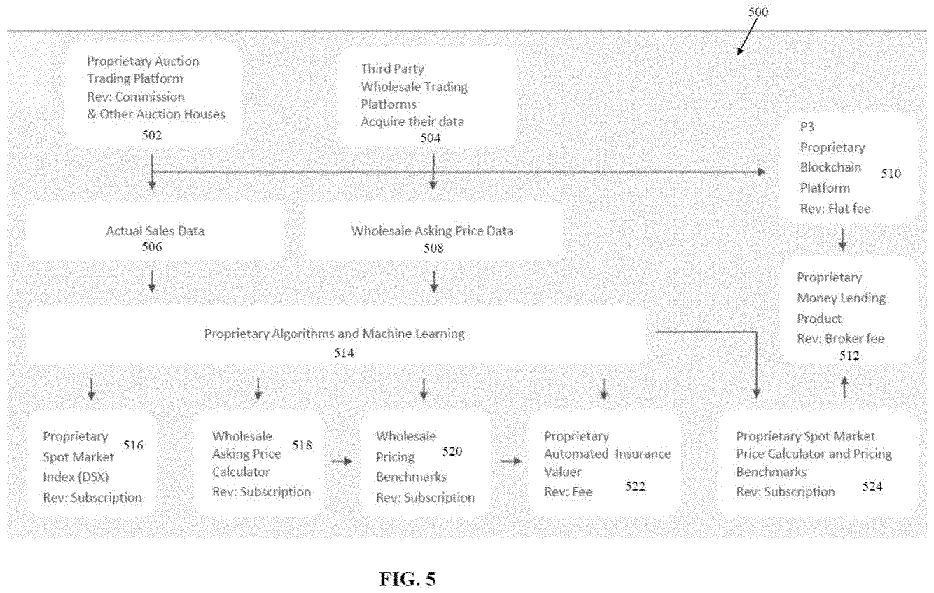

Referring now to FIG. 5, a flow chart 500 depicts illustrative steps which may be taken in accordance with various features of the subject matter. In steps 502 and 504, an auction trading platform and a third party wholesale trading platform may continuously provide a plurality of actual sales data 506 and a plurality of wholesale asking price data 508, respectively, to server 102 over network 106. In some embodiments, steps 502 and 504 are performed simultaneously; however it is to be understood the initial received data may include the plurality of variable data for the purpose of generating an insurable value of diamond asset 116 that does not account for plurality of actual sales data 506, and the plurality of actual sales data 506 may be subsequently collected and integrated into machine learning module 206 in future iterations; for example, when machine learning module 206 is generating outputs that do not require plurality of actual sales data 506. At step 510, a proprietary blockchain platform (operated by provider 118) receives applicable data from the auction trading platform and the third party wholesale trading platform, which is ultimately received by a proprietary money lending product 512 in a securitized manner, in which the securitization may include data encryption mechanisms provided by server 102 and/or provider 118. At step 514, machine learning module 206 receives the plurality of actual sales data 506 and the plurality of wholesale asking price data 508 in the form of training data configured to train a classification model via one or more proprietary algorithms and machine learning techniques 514. Applicable outputs of one or more proprietary algorithms and machine learning techniques 514 are transmitted to one or more of a proprietary spot market index (DSX) 516, a wholesale asking price calculator 518, one or more wholesale pricing benchmarks 520, a proprietary automated insurance valuer 522, and/or a proprietary spot market price calculator and pricing benchmarks 524. In some embodiments, data derived from calculators and benchmarks 516-524 is transmitted to proprietary money lending product 512. It is to be understood that calculators and benchmarks 516-524 may be configured to generate one or more applicable graphical representations configured to represent the change of value over a period of time for at least one of general value of diamond asset 116, wholesale value of diamond asset 116, spot market value of diamond asset 116, insurable value of diamond asset 116, and/or the diamond standard. For example, the one or more applicable graphical representations may depict scatterplot-type depiction reflecting the range of diamond asset 116, in which x axis may account for time and the y axis may account for money and/or value. It is to be understood that the aforementioned axes may account for time, money, and any of the aforementioned physical characteristics inherent to diamond asset 116 and/or value fluctuation factors.

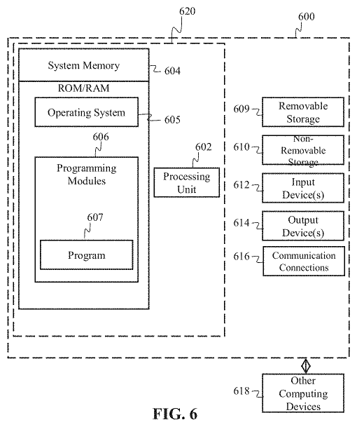

FIG. 6 is a block diagram of a system including an example computing device 600 and other computing devices. Consistent with the embodiments described herein, the aforementioned actions performed by devices 110, 114, and server 102 may be implemented in a computing device, such as the computing device 600 of FIG. 6. Any suitable combination of hardware, software, or firmware may be used to implement the computing device 600. The aforementioned system, device, and processors are examples and other systems, devices, and processors may include the aforementioned computing device. Furthermore, computing device 600 may include an operating environment for system 100 and process/method 400. Process 400, and data related to said processes may operate in other environments and are not limited to computing device 600.

With reference to FIG. 5, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may include, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of server 102 and devices 110 and 114, for example. Furthermore, embodiments of the invention may be practiced in conjunction with a graphics library, other operating systems, or any other application program and is not limited to any particular application or system. This basic configuration is illustrated in FIG. 5 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 5 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the process 400 as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

The claims appended hereto are meant to cover all modifications and changes within the scope and spirit of the present invention.

What is claimed is:

1. A system for facilitating transactions for a diamond asset comprising:
a processor designed and configured to:
receive a plurality of unique identifying data associated with the diamond asset;
register an asset identifier for the diamond asset on a distributed ledger;
establish an obligation as a smart loan contract configured to be maintained on the distributed ledger based on the diamond asset identifier, wherein the obligation includes a designated evaluator;
generate, based on a lender action provided by the lender, a first additional block memorializing the obligation;
store as a second additional block, based on an evaluator action provided by the evaluator, an evaluation certification associated with the diamond asset; and
establish a plurality of access rights to the first additional block based on the evaluation certification.

2. The system of claim 1, wherein the processor is further configured to:
allocate the plurality of access rights to the first additional block to the applicable party based upon the underwriter indicating existence of insurance of the diamond asset on behalf of the lender.

3. The system of claim 1, wherein the processor is further configured to:
determine if a borrower defaulted on the diamond asset based on an inability of the lender to recover the diamond asset within a predetermined time period.

4. The system of claim 3, wherein the processor is further configured to:
transmit a title associated with the diamond asset based on the determination.

5. The system of claim 1, wherein the processor is further configured to:
store training data that comprises a plurality of training instances, each of which includes a plurality of feature values derived from the plurality of unique identifying data;
utilize one or more machine learning techniques to train a classification model based on the training data;
identify a first plurality of diamond-specific feature values of one or more value factors associated with the evaluation certification;
based on the first plurality of diamond-specific feature values, determine whether the one or more value factors pertains to the diamond asset;
wherein the determination includes inserting the first plurality of feature values into the classification model that generates an output that indicates the value of the diamond as set.

6. The system of claim 5, wherein the processor is further configured to:
insert the output in the first additional block of the distributed ledger based on the evaluation certification designated evaluator.

7. The system of claim 1, wherein the processor is further configured to:
receive a plurality of sales data associated with an asset auction relating to an applicable platform.

8. The system of claim 1, wherein the smart loan contract includes at least the output validated by the evaluation certification.

9. The system of claim 1, wherein the plurality of access rights includes at least one of a read access, write access, or read and write access to the applicable block of the distributed ledger.

10. A method for generating a value of a diamond asset comprising:
identifying a plurality of initialization feature values of the diamond asset;
storing training data that comprises a plurality of training instances, each of which is derived from the plurality of initialization features values;
using one or more machine learning techniques to train a classification model based on the training data;
identifying a second plurality of feature values derived from a plurality of newly acquired data;
correlating the second plurality of feature values to the plurality of initialization feature values;
wherein correlating comprises inserting the second plurality of feature values into the classification model that generates an output that indicates the value of the diamond asset; and
storing the output on at least one block on a distributed ledger.

11. The method of claim 10, further comprising:
storing a diamond collateralized loan (DCL) in a first additional block of the distributed ledger; and
including the output in the DCL based on a received evaluation certification.

12. The method of claim 10, further comprising:
storing an evaluation certification validating the output in a second additional block of the distributed ledger.

13. The method of claim 11, further comprising:
establishing a plurality of access rights to the first additional block and a second additional block of the distributed ledger based on the DCL.

14. A method of claim 11, wherein correlating the second plurality of feature values comprises:
applying a classification boundary in order to determine whether at least a subset of the second plurality of feature values pertain to the diamond asset.

15. A system for generating an insurance quote for a diamond asset comprising:
at least a processor designed and configured to:
receive a plurality of unique identifying data associated with the diamond asset;
receive a plurality of sales data associated with an asset auction;
receive an evaluation certification associated with the diamond asset;
store training data that comprises a plurality of training instances, wherein each training instance in the plurality of training instances corresponds to at least one of the plurality of unique identifying data, the plurality of sales data, and the evaluation certification;
use one or more machine learning techniques to train a classification model based on the training data and define a classification boundary based on the plurality of training instances;
generate an output, based on the classification model and applying the classification boundary, representing an insured value for the diamond asset;
establish an obligation associated with the diamond asset configured to be maintained on the distributed ledger;
generate a first additional block on the distributed ledger memorializing the obligation via a smart contract;
store the output and the evaluation certification on a second additional block on the distributed ledger.

16. The system of claim 15, wherein the processor is further configured to:
store the output in the smart contract based on the evaluation certification validating the insured value for the diamond asset.

17. The system of claim 15, wherein the processor is further configured to:
apply the classification boundary in order to determine whether one or more of the plurality of unique identifying data, plurality of sales data, and evaluation certification pertain to the diamond asset.

18. The system of claim 15, wherein the processor is further configured to:
establish a plurality of access rights to the first additional block and the second additional block of the distributed ledger based on the smart contract.

19. The system of claim 15, wherein the processor is further configured to:
determine if a borrower defaulted on the diamond asset based on an inability of a lender to recover the diamond asset within a predetermined time period.

20. The system of claim 19, wherein the processor is further configured to:
transmit a title associated with the diamond asset to an applicable party of the smart contract based on the determination.

21. A system for generating an insurable value for a diamond asset comprising:
at least a processor designed and configured to:
receive a plurality of unique identifying data associated with the diamond asset;
receive a plurality of variable data;
store training data that comprises a plurality of training instances, wherein each training instance in the plurality of training instances corresponds to at least one of the plurality of unique identifying data and the plurality of variable data;
use one or more machine learning techniques to train a classification model based on the training data and define a classification boundary based on the plurality of training instances;
generate an output, based on the classification model and applying the classification boundary, representing an insured value for the diamond asset;
establish an obligation associated with the diamond asset configured to be maintained on the distributed ledger;
generate a first additional block on the distributed ledger memorializing the obligation via a smart contract;
store the output and the evaluation certification on a second additional block on the distributed ledger.
